(19) United States
(12) Patent Application Publication
(10) Pub. No.: US 2004/0185193 A1
(43) Pub. Date: Sep. 23, 2004

(54) Ink-jet recording sheet

(75) Inventors: Yukako Taka, Tokyo (JP); Keiji Ohbayashi, Tokyo (JP)

Correspondence Address: Finnegan, Henderson, Farabow, Garrett & Dunner, L.L.P., 1300 I Street, N.W., Washington, DC, 20005-3315, US

(73) Assignee: KONICA MINOLTA HOLDINGS, INC.

(21) Appl. No.: 10/800,660

(22) Filed: Mar. 16, 2004

(30) Foreign Application Priority Data
Mar. 20, 2003 (JP) JP2003-077671

(51) Int. Cl. B41M 5/00

(52) U.S. Cl. 428/32.18

(57) ABSTRACT

An ink-jet recording sheet comprising a paper support coated with a polyolefin resin on both sides of the paper support, the polyolefin resin-coated paper support having thereon a porous ink receptive layer containing a hydrophilic polymer, wherein the paper support has a ratio of a Cobb value to a basis weight of not more than 0.05:1 to 0.4:1.

### TECHNICAL FIELD

The present invention relates to a novel ink-jet recording sheet resulting in silver salt photographic quality, and in more detail to an ink-jet recording sheet resulting in silver salt photographic quality with minimal curling as well as minimal edge wave under varying of ambient humidity.

### BACKGROUND

In recent years, ink-jet recording sheets which result in image quality approaching that of silver salt photography have increasingly been used. Of these, an ink-jet recording sheet which comprises a support, comprised of a base paper coated on both sides with polyolefin resins such as polyethylene, having thereon a porous ink absorptive layer which exhibits high ink absorbability, is increasingly used to easily produce high quality prints approaching those of silver salt photography due to advantages such as relatively low cost compared to plastic film, roust feeling, flexibility, smoothness, glossiness, or in addition, easy realization of various textures such as a silk surface or a matte surface. Many ink-jet recording sheets constituted as above are commonly known.

However, ink-jet recording sheets which comprise a support comprised of a base paper coated on both sides with polyolefin resins thereon provided with an ink absorptive layer are comprised of at least four layers. As a result, they exhibit disadvantages such that when ambient conditions, under which ink-jet recording sheets are stored, vary and especially when humidity varies markedly, various kinds of curling as well as edge waving tend to occur.

More specifically, the base paper exhibits characteristics such as elongation under conditions of high humidity, and on the contrary, shrinkage under low humidity. On the other hand, the elongation and shrinkage ratio of the polyolefin resinous layer coated on both sides of the base paper is customarily smaller than that of the base paper. As a result, due to the difference in elongation and shrinkage properties between both, ink-jet recording sheets result in various types of curling under various humidity ambiences in which ink-jet recording sheets are stored.

Further, since the front and rear surfaces of the support are covered by polyolefin resins, the front and rear surfaces of the support generally result in minimal variation of moisture. However, on edges of the ink-jet recording sheets, in the cross-sectional portion, the employed base paper is exposed. As a result, when moisture enters or exits side surface, the edges of the base paper are deformed to result in edge so-called wave.

The degree of such curling as well as edge wave phenomena depends largely on the constitution of the ink absorptive layer. In current ink-jet printers, an increase in printing speed as well as improvements for image quality is increasingly attempted, resulting in a decrease in the gap between the ink-jet recording sheet and the recording head. As a result, the aforesaid curling and edge wave phenomena not only degrade print quality but also become factors in various problems due to poor conveyance.

Specifically, problems tend to occur in which the recording head tends to rub against the ink-jet recording sheets, and streaking tends to occur due to variation of the distance between the ink-jet recording sheet and the recording head.

Customarily, curling of supports is appropriately controlled by controlling the composition (the ratio of low density polyethylene or high density polyethylene) of polyolefin resins on the front and rear surfaces or the ratio of thickness of polyolefin resins on the front and rear surfaces.

Assuredly, it is possible to control to some extent curling employing the aforesaid means. However, the edge wave which occurs particularly during storage of ink-jet recording sheets under high humidity conditions has not yet been minimized.

Edge wave is minimized by increasing the stiffness of the base paper. In this case, it is common to increase paper thickness. However, in view of attainment of silver salt photographic quality, an adverse feeling of difference results.

Ink-jet recording sheets having a porous ink absorptive layer exhibiting a high ink absorption rate, which are increasingly employed in recent years, are comprised of at least a 30 μm thick ink absorptive layer. As a result, it becomes harder to control curling. Due to the addition of such adverse curling characteristics, the aforesaid edge wave also increases. Specifically, when ink-jet recording sheets stored under high humidity conditions are transferred to a low humidity ambience, the aforesaid problems are more pronounced when the curling and the edge wave are combined.

Heretofore, in order to overcome the aforesaid drawbacks, it has been proposed to use various supports for ink-jet recording sheets which comprise a support comprised of a base paper coated on both sides with polyolefin resins having thereon an ink absorptive layer.

For example, proposed are supports in which the moisture of the base paper is controlled to a specified value (refer, for example, to Patent Documents 1-3). On the other hand, proposed are supports which result in recording sheets having various textures by embossing the supports (refer, for example, to Patent Documents 4-7). Further, proposed is a support having curl characteristics in the specified range (refer, for example, to Patent Document 8). Curl characteristics of all supports proposed above are described. However, no description is made for methods and specific means to minimize the edge wave of ink-jet recording sheets which comprise a support coated on both sides with polyolefin resins, which is the objective of the present invention.

(Patent Document 1)

Japanese Patent Publication Open to Public Inspection (hereinafter referred to as JP-A) No. 2000-85243 (Claims)

(Patent Document 2)

JP-A No. 2001-96895 (Claims)

(Patent Document 3)

JP-A No. 2001-96898 (Claims)

(Patent Document 4)

JP-A No. 2000-296667 (Claims)

(Patent Document 5)

JP-A No. 2000-296669 (Claims)

(Patent Document 6)

JP-A No. 2001-347748 (Claims)

(Patent Document 7)

JP-A No. 2001-63205 (Claims)

(Patent Document 8)

JP-A No. 2001-10203 (Claims)

An object of the present invention is to provide an ink-jet recording sheet which minimizes curling under variations of ambient humidity as well as edge wave, and also minimizes image problems and rubbing by heads during ink-jet printing.

### SUMMARY

The object of the present invention can be achieved by the following embodiments.

1. An ink-jet recording sheet comprising a paper support coated with a polyolefin resin on both sides of the paper support, the polyolefin resin-coated paper support having thereon a porous ink receptive layer containing a hydrophilic polymer, wherein the paper support has a ratio of a Cobb value to a basis weight of not more than 0.05:1 to 0.4:1.

2. The ink-jet recording sheet of Item 1, wherein the paper support contains water in an amount of 5 to 8 weight % based on the total weight of the paper support.

3. The ink-jet recording sheet of Item 1, wherein the paper support has a basis weight of not less than 100 g/m².

### DESCRIPTION OF THE PREFERRED EMBODIMENTS

The present invention will now be detailed.

The support which is employed for the ink-jet recording sheet (hereinafter also referred simply to as the recording sheet) is one which is comprised of a base paper coated on both sides with polyolefin resins.

Base paper employed for the support according to the present invention is made employing wood pulp as the main raw material, and if desired, employing synthetic pulp such as polypropylene, or synthetic fiber such as nylon or polyester. As wood pulp, any of LBKP, LBSP, NBKP, NBSP, LDP, NDP, LUKP, and NUKP may be employed.

As the above-mentioned pulp, chemical pulp (sulfate salt pulp and sulfite pulp), containing minimum impurities, is preferably employed, and pulp, which has been subjected to bleaching treatment employing ozone, chlorine based bleaching agents or hydrogen peroxide to increase whiteness, is also beneficial.

Added to base paper as suitable may be sizing agents such as higher fatty acids or alkylketene dimers, white pigments such as calcium carbonate, talc, or titanium oxide, paper strength enhancing agents such as starch, alkylamides, or polyvinyl alcohols, optical brightening agents, moisture retaining agents such as polyethylene glycols, dispersing agents, and softening agents such as quaternary ammonium.

The freeness of pulp employed for paper making is preferably 200-500 ml under the specification of CSF. Further, regarding fiber length after beating, the sum of the 24 mesh residue and the 42 mesh residue, specified in JIS P 8207, is preferably 30-70 percent. Incidentally, 4 mesh residual is preferably at most 20 percent.

The basis weight of base paper is customarily 50-250 g/m². However, in the present invention, it is preferably at least 100 g/m², and is more preferably 100-200 g/m².

Basis weight of less than 100 g/m² results in minimal effects to retard the formation of the edge wave due to the low stiffness of the paper. On the other hand, when the basis weight exceeds 200 g/m², the edge wave as well as the degree of curl is minimized, but besides an increase in cost, problems such as poor conveyance in ink-jet printers tend to occur due to excessively high weight and stiffness.

The present invention is characterized in that the degree of Cobb sizing per basis weight of base paper is specified to be at most 0.4. In view of minimizing edge wave, the condition specified herein is critical.

The degree of Cobb sizing, as described in the present invention, is determined based on JIS P 8140.

When the degree of Cobb sizing per basis weight of the base paper according to the present invention exceeds 0.4, edge wave tends to occur. The aforesaid ratio is preferably at most 0.3, and is particularly preferably at most 0.2. The lower limit is not particularly limited. However, in view of cost and production adaptability, the ratio is commonly at least 0.05.

The degree of Cobb sizing is usually controlled to be within the range specified in the present invention, employing means in which the amount of sizing agents, known in the art, such as neutral rosin, alkenyl succinic anhydride, or alkylketene dimers is controlled. Further, it is possible to control it, to some extent, by controlling the proportion of various fillers and calendaring conditions of the aforesaid paper.

Listed as fillers in the base paper are conventional fillers such as calcium carbonate, precipitated calcium carbonate, calcium carbonate heavy, kaolin, talc, magnesium silicate, satin white, synthetic non-crystalline silica, or zinc oxide. It is preferable to add these fillers as ash in an amount of 3-15 percent by weight with respect to base paper.

It is possible to provide base paper with high smoothness through calendaring during the paper making stage or after paper making. Paper density is customarily 0.7-1.2 g/cm³ (JIS P 8118). Further, stiffness of the base paper is preferably 20-200 g under the conditions specified in JIS P 8143.

The surface of base paper may be coated with surface sizing agents. Used as surface sizing agents may be the same sizing agents as those which can be added to the base paper.

The pH value of base paper is preferably 5-9, when determined employing the hot water extraction method specified in JIS P 8113.

Density of base paper is preferably in the range of 0.9-1.1.

Further, in view of the fact that as dimensional stability of base paper increases, curling stability increases and edge wave is minimized, the lateral water immersion elongation test value, based on J TAPPI No. 27, is commonly at most 3 percent, is preferably at most 2 percent, and is most preferably at most 1.5 percent.

Polyolefin resins which are coated on both sides of the aforesaid base paper will now be described.

Listed as polyolefin resins employed for this purpose are polyethylene, polypropylene, polyisobutylene, and polyethylene. Polyolefins such as copolymers comprising propylene as a major component are also preferred. Of these, polyethylene is particularly preferred.

Particularly preferred polyethylene will now be described.

Polyethylene which is applied onto the front and rear surfaces of base paper is mainly comprised of low density polyethylene (LDPE) and/or high density polyethylene (HDPE). It is possible to partially use others such as LLDPE or polypropylene.

The polyolefin layer on the side onto which a porous ink absorptive layer is applied is preferably one into which rutile or anatase type titanium dioxide is incorporated to enhance opacity and whiteness. The amount of titanium oxide is customarily 1-20 present with respect to the polyolefins, and is preferably 2-15 percent.

In order to control white background, it is possible to add high heat resistant pigments and optical brightening agents to the polyolefin layer.

Listed as colored pigments are ultramarine blue, Prussian blue, cobalt blue, phthalocyanine blue, manganese blue, cerulean blue, molybdenum blue, and anthraquinone blue.

Listed as optical brightening agents are dialkylaminocoumarin, bisdimethylaminostilbene, bismethylaminostilbene, 4-alkoxy-1,8-naphthalenedicarboxylic acid-N-aklylimide, bisbenzoxazolylethylene, and dialkylstilbene.

The used amount of polyolefins which is applied onto the front and rear surfaces of base paper is selected so that the thickness of the ink absorptive layer and the degree of curl under low and high humidity after providing the back layer are optimized. The thickness of the polyolefin layer on the ink absorptive layer side is customarily 15-40 μm, and the same on the back layer side is in the range of 15-50 μm. It is preferable that the ratio of polyolefins on the front surface to the rear surface is set so as to control curl which varies depending on the types and thickness of the ink receptive layer as well as the thickness of the core paper. The ratio of polyolefins on the front to the rear surface is commonly 3/1-1/3 in terms of thickness.

It is possible to use various textures for the polyolefin resin layer. Specifically, in the present invention, employed may be supports having specular glossiness, polyolefin resin coated paper for glossy paper such as supports having appropriate gloss which are subjected to a fine-grained surface treatment, described, for example, in JP-A No. 2001-63204, and supports which are embossed to result in textures such as a silk surface or a matte surface, described, for example, in JP-A Nos. 2000-296-667, 2000-296669, 2001-347748, and 2001-63205.

In view of stabilizing curling, the moisture content of base paper is preferably 5-8 percent by weight. When the moisture content is less than 5 percent by weight, the edge wave tends to increase when the base paper is stored at high humidity. When moisture exceeds 8 percent by weight, on the contrary, curling tends to increase when stored at low humidity.

Further, it is preferable that the aforesaid polyolefin coated paper supports exhibit characteristics represented by following items (1)-(6).

(1) Tensile strength specified in JIS P 8113 is preferably 2-300 N in the longitudinal direction and 10-200 N in the lateral direction,

(2) Tear strength specified in JIS P 8116 is preferably 0.1-2 N in the longitudinal direction and 0.2-2 N in the lateral direction,

(3) Compression modulus of elasticity is preferably 9.8 kN/cm²,

(4) Opacity is preferably at least 80 percent, and is most preferably 85-98 percent, when measured employing the method specified in JIS P 8138,

(5) Whiteness preferably has L*, specified in JIS Z 8729, from 80 to 97, a*, specified in JIS Z 8729, from −3 to +5, and b*, specified in JIS Z 8729, from −6 to +2, and

(6) Clark stiffness of the support is preferably 50-300 cm^{2/100} in the recording sheet conveyance direction.

It is preferable that prior to coating of an ink absorptive layer, the aforesaid polyolefin resin coated support is provided with a sublayer comprised mainly of hydrophilic polymers.

Employed as hydrophilic polymers employed for the sublayer may be prior art hydrophilic polymers such as gelatin or its derivatives, polyvinyl alcohols or their derivatives, polyvinylpyrrolidone, polyethylene oxides, carboxymethylcellulose, hydroxyethylcellulose, starch or its derivatives, carrageenan, gum Arabic, or Pullulan. These hydrophilic polymers may be employed in combinations of at least two types.

Particularly preferred hydrophilic polymers are gelatin or its derivatives as well as polyvinyl alcohols and their derivatives. Of these, the polyvinyl alcohols or their derivatives are particularly preferred.

Employed as suitable in the sublayer may be hardening agents, surface active agents, silane coupling agents, titanium coupling agents, toning agents, optical brightening agents, matting agents, or pH control agents.

When hydrophilic polymers incorporated in the sublayer are gelatin or its derivatives and polyvinyl alcohoss or their derivatives, it is preferable that hardening agents which are suitable for these polymers are incorporated to minimize cracking. When, after coating the sublayer, these hardeners are added prior to coating an ink absorptive layer and the ink absorptive layer is coated, the sublayer hardens to retard swelling. As a result, it is assumed that during drying after coating the ink absorptive layer, the contraction stress in a hard porous layer decreases, whereby cracking tends to be minimal.

When hydrophilic polymers which are employed in the sublayer are comprised mainly of gelatin or its derivatives, employed as preferred hardeners are, for example, vinylsulfone based hardeners, acryloyl based hardeners, aldehyde based hardeners, epoxy based hardeners, and active halogen type hardeners.

Further, when hydrophilic polymers are polyvinyl alcohols or their derivatives, examples of preferred hardeners include boron based hardeners such as boric acid or borax and epoxy based hardeners. The added amount of these hardeners is customarily 0.001-0.5 g per g of the hydrophilic polymers.

The aforesaid sublayer is provided on the polyolefin resinous layer. In view of adhesion properties, it is preferable that prior to coating the sublayer, the surface of the polyolefin resinous layer is subjected to surface activation treatment such as plasma treatment, flame treatment, or corona discharge treatment.

Subsequently, an ink absorptive layer provided on the aforesaid support will be described.

The ink absorptive layer may be provided on either one side or both sides of the support. In such a case, the ink absorptive layers provided on both sides may be the same or different.

The ink absorptive lawyer of the ink-jet recording sheet of the present invention is a porous ink absorptive layer.

The thickness of the porous ink absorptive layer of the present invention is preferably from 20 to 60 μm, and more preferably from 25 to 55 μm.

It is preferable that the porous ink absorptive layer is comprised of a porous layer having a void layer formed employing minute inorganic or organic particles and a small amount of hydrophilic polymers.

Preferred as minute particles are minute inorganic particles. Listed as examples such minute inorganic particles may be white inorganic pigments such as precipitated calcium carbonate, calcium carbonate heavy, magnesium carbonate, kaolin, clay, talc, calcium sulfate, barium sulfate, titanium dioxide, zinc oxide, zinc hydroxide, zinc sulfides, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, or magnesium hydroxide. Minute inorganic particles may be employed in the form of primary particles without any modification, or in the form of secondary coagulated particles.

In the present invention, particularly in view of being capable of forming microscopic voids, preferred is silica or pseudo-boehmite. Specifically, silica at an average particle diameter of at most 100 nm, synthesized employing a vapor process method, colloidal silica, or pseudo-boehmite is preferred.

The average diameter of minute inorganic particles is determined as follows. The particles themselves, or the cross-section or surface of a void layer is observed employing an electron microscope, and the diameter of 100 randomly selected particles is determined. Subsequently, a simple average value (a number average) is obtained based on values obtained as above. Herein, each particle diameter is represented by the diameter of the circle which has the same area as the projected area of each particle.

Listed as hydrophilic polymers employed for the void layer are gelatin (alkali process gelatin, acid process gelatin, and gelatin derivatives in which the amino group is blocked by phenyl isocyanate or phthalic anhydride), polyvinyl alcohols (preferably at a degree of polymerization of 300-4,000 and a saponification ratio of 80-99.5 percent), polyvinylpyrrolidone, polystyrene oxides, hydroxyethylcellulose, agar, Pullulan, dextran, acrylic acid, carboxymethylcellulose, casein, and alginic acid. These may be employed in combinations of at least two types. Of these, particularly preferred hydrophilic polymers are polyvinyl alcohols or derivatives thereof.

Other than common polyvinyl alcohol prepared by hydrolyzing polyvinyl acetate, polyvinyl alcohols employed in the present invention include modified polyvinyl alcohols such as cation-modified polyvinyl alcohol at the terminal, as well as anion-modified polyvinyl alcohol having an anionic group.

The average degree of polymerization of polyvinyl alcohol prepared by hydrolyzing vinyl acetate is preferably at least 300, and is most preferably 1,000-5,000. Those at a saponification ratio of 70-100 percent are preferred, and those at the same of 80-100 percent are particularly preferred.

The ratio of hydrophilic polymers of the porous ink absorptive layer to minute particles is commonly in the range of 1:10-1:2, and preferably 1:8-1:3.

Further, when the aforesaid porous ink absorptive layer comprises polyvinyl alcohols as a hydrophilic polymer, in order to improve filming properties of the resulting layer and to enhance water resistance as well as strength of the resulting layer, it is preferable to use hardening agents. Preferred as hardening agents are boric acids or salts thereof and epoxy based hardeners. Of these, particularly preferred are boric acids.

Boric acids or salts thereof, as described herein, refer to oxygen acids having a boron atom as the central atom and salts thereof, and specifically include orthoboric acid, metaboric acid, hypoboric acid, tetraboric acid, and pentaboric acid, as well as salts thereof.

The used amount of boric acids or salts thereof may vary widely depending on the amount of minute inorganic particles and hydrophilic polymers in the liquid coating composition, but is commonly 1-60 percent with respect to the hydrophilic polymers, and is preferably 5-40 percent.

Incidentally, when hydrophilic polymers themselves used in the porous layer are crosslinkable, hardening agents are not always necessary.

It is possible to add various additives, other than those described above, to the ink absorptive layer of the ink-jet recording sheet of the present invention. Of these, in order to enhance water resistance as well as moisture resistance after printing, cationic mordants are preferably employed. Employed as cationic mordants are polymers having a primary, secondary, or tertiary amino group, or a quaternary ammonium salt group. Based on the fact that discoloration during storage over an extended period is minimized, lightfastness is not degraded, and dye-mordanting capability is sufficiently high, polymer mordants having a quaternary ammonium salt group are preferred.

Preferred polymer mordants are prepared as homopolymers of monomers having the aforesaid quaternary ammonium salt group, or as copolymers or condensation polymers with other monomers.

Specific examples of cationic mordants are listed, for example, on page 268 of “Ink-jet Printer Gijutsu (Ink-jet Printer Technology)” (issued by CMC Co., Ltd., 1998).

Other than the aforesaid additives, it is possible to incorporate various prior art additives such as UV absorbers, described in JP-A Nos. 57-74193, 57-87988, and 62-261476; anti-discoloring agents, described in JP-A Nos. 57-74192, 57-87989, 60-72785, 61-146591, 1-95091, and 3-13376; various anionic, cationic, or nonionic active agents; optical brightening agents, described in JP-A Nos. 59-42993, 59-52689, 62-280069, 61-242871, and 4-219266; water-soluble multivalent metal compounds such as basic polyaluminum hydroxide or zirconyl acetate, described in JP-A No. 2000-309157; defoamers, lubricating agents such as ethylene glycol, antiseptics, thickeners, and antistatic agents.

Examples of methods for coating the ink absorptive layer onto a support include a roll coating method, a rod bar coating method, an air knife coating method, a spray coating method, a curtain coating method, and an extrusion coating method employing a hopper, described in U.S. Pat. No. 2,681,294. Since it is required that a porous layer is coated at a relatively high wet layer thickness, the curtain coating method or the extrusion coating method is preferably employed.

Drying after coating the ink absorptive layer can be carried out employing commonly used drying methods and conditions, and is commonly carried out at 20-80° C. A method in which a coating is temporarily gelled after coating is suitable for high speed coating because it is possible to use a relatively strong air flow.

Since a polyolefin resin coated paper is used as a support, drying is preferably carried out in the range of 0-80° C. When the temperature exceeds 80° C., polyolefin resins are softened to occasionally result in difficulty of conveyance and uneven gloss on the resulting recording layer surface. A preferable drying temperature is from 0 to 60° C.

In order to minimize curling, adhesion of stacked sheets immediately after printing, and ink transfer, it is possible to provide various types of back layers onto the ink-jet recording sheet of the present invention.

The constitution of the back layer varies depending on the types and thickness of supports, and the constitution and thickness on the surface side. Commonly, employed are hydrophilic binders and hydrophobic binders. The thickness of the back layer is customarily in the range of 0.1-10 μm.

Further, in order to improve electrostatic characteristics, electrically conductive materials may be incorporated into the back layer. In order to minimize adhesion to other recording sheets, and improve writability and sheet tracking properties in ink-jet recording apparatuses, the sheet surface may be roughened. For this purpose, minute organic or inorganic particles at a diameter of 0.5-20 μm are preferably employed.

Such a back layer may be provided after coating the ink absorptive layer, however, it is preferable that it is previously provided.

### EXAMPLES

The present invention will now be described with reference to examples. However, the present invention is not limited thereto. “Percent” in the examples refers to absolute dry percent by weight, unless otherwise indicated.

### Example 1

<<Preparation of Supports>>

A liquid slurry was prepared which was comprised, per 100 parts of wood pulp (LBKP/NBSP=50/50), of 1 part of polyacryl amide, 4 parts of ash (talc), 2 parts of cationic starch, 0.5 part of a polyamidoepichlorohydrin resin, and an alkylketene dimer (a sizing agent) in the amount necessary for achieving the degree of Cobb sizing per basis weight described in Table 1. Subsequently, Base Papers 1-5 were made employing a continuous paper making machine to result in a basis weight of 170 g/m². After calendaring the resulting paper, a low density polyethylene resin, at a density of 0.92, comprising 4 weight percent anatase type titanium dioxide and a small amount of color tone controlling agents, was applied employing a melt extrusion coating method at 320° C. onto one side of the resulting paper to achieve a thickness of 28 μm. Subsequently, a melted mixture of high density polyethylene at a density of 0.96 and low density polyethylene at a density of 0.92 at a ratio of 70/30 was applied onto another side to achieve a thickness of 32 μm, also employing a melt extrusion coating method. The titanium oxide containing side of the resulting support was subjected to corona discharge, and was then coated with a sublayer comprised of polyvinyl alcohol, boric acid, and surface active agents to achieve a coated polyvinyl alcohol of 0.05 g/m².

The surface of the other side was coated with a styrene/acryl based emulsion comprising a small amount of cationic polymers (being electrically conductive agents) to result in a dried layer thickness of 0.5 μm, whereby Supports 1-5 to be coated with an ink absorptive layer were prepared.

The 75-degree glossiness of the surface to be provided with the ink absorptive layer was 60-61 percent, while the center line average roughness (SRa) was approximately 0.22 μm.

The glossiness of the rear surface was approximately 18 percent, while SRa thereof was approximately 2.5 μm, and Beck smoothness was 160-200 seconds.

The moisture content of the base paper of Supports 1-5, prepared as above, was 7.0-7.2 percent.

Table 1 shows the values of the degree of Cobb sizing/basis weight of 5 types of base papers.

<<Preparation of Ink-jet Recording Sheets>>

(Preparation of Dispersion)

<Preparation of Titanium Oxide Dispersion 1>

Added to 90 L of an aqueous solution, at a pH of 7.5, containing 150 g of sodium tripolyphosphate, 500 g of polyvinyl alcohol (PVA235, manufactured by Kuraray Co., Ltd.), 150 g of cationic polymer (P-1), and defoamer SN381 available from San Nobuko Co. was 20 kg of titanium oxide having an average particle diameter of 0.25 μm (W-10, manufactured by Ishihara Sangyo Kaisha, Ltd.). After dispersing the resulting mixture employing a high pressure homogenizer (manufactured by Sanwa Industry Co., Ltd.), the total volume was raised to 100 L, whereby uniform Titanium Oxide Dispersion 1 was prepared.

P-1

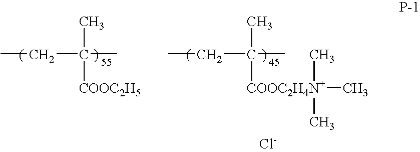

<Preparation of Silica Dispersion 1>

Silica Dispersion 1 was prepared by successively mixing of the additives below.

| | | |
|---|---|---|
| Water | 71 | L |
| Boric Acid | 0.27 | kg |
| Borax | 0.24 | kg |
| Ethanol | 2.2 | L |
| Cationic polymer (P-1) | 17 | L |
| 10 percent aqueous anti-discoloring | 8.5 | L |
| agent (AF-1) solution | | |
| Aqueous optical brightening agent | 0.1 | L |
| solution (Uvitex NFW Liquid, | | |
| manufactured by Ciba Specialty | | |
| Chemical) | | |
| Water to make | 100 | L |

As minute inorganic particles, 50 kg of vapor phase process silica (having an average primary particle diameter of approximately 12 nm) was collected and mixed with each of the aforesaid liquid additive compositions. Thereafter, the resulting mixture was dispersed employing the dispersion method described in the example of JP-A No. 2002-47454, whereby Silica Dispersion 1 was prepared.

Anti-discoloring agent (AF-1): HO-N(C₂H₄SO₃Na)₂

<Preparation of Silica Dispersion 2>

Silica Dispersion 2 was prepared in the same manner as Silica Dispersion 1, except that cationic polymer P-1 was replaced with P-2.

P-2

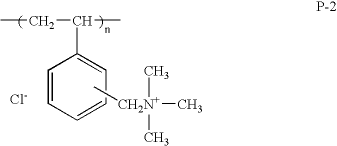

(Preparation of Coating Liquid Compositions)

Each of the liquid coating compositions for the first layer, second layer, third layer, and fourth layers on the ink absorptive layer side was prepared employed the steps described below.

(Preparation of First Layer Liquid Coating Composition)

While stirring at 40° C., the additives listed below were successively mixed with 610 ml of aforesaid Silica Dispersion 1.

| | | |
|---|---|---|
| 5 percent aqueous polyvinyl alcohol (PVA235, | 220 | ml |
| manufactured by Kuraray Industry Co., | | |
| Ltd.) solution | | |
| 5 percent aqueous polyvinyl alcohol (PVA245, | 80 | ml |
| manufactured by Kuraray Industry Co., | | |
| Ltd.) solution | | |
| Titanium Oxide Dispersion 1 | 30 | ml |
| Latex emulsion (AE-803, manufactured by | 21 | ml |
| Dai-ichi Kogyo Co., Ltd.) | | |
| 5 percent aqueous Surface Active Agent 1 | 1.5 | ml |
| solution | | |

The total volume was brought to 1,000 ml by the addition of pure water.

(Preparation of Second Layer Liquid Coating Composition)

While stirring at 40° C., 650 ml of aforesaid Silica Dispersion 1 was successively mixed with the following additives.

| | | |
|---|---|---|
| 5 percent aqueous polyvinyl alcohol (PVA235, | 180 | ml |
| manufactured by Kuraray Industry Co., | | |
| Ltd.) solution | | |
| 5 percent aqueous polyvinyl alcohol (PVA245, | 80 | ml |
| manufactured by Kuraray Industry Co., | | |
| Ltd.) solution | | |
| Latex emulsion (AE-803, manufactured by | 15 | ml |
| Dai-ichi Kogyo Co., Ltd.) | | |

The total volume was brought to 1,000 ml by the addition of pure water.

(Preparation of Third Layer Liquid Coating Composition)

While stirring at 40° C., 650 ml of aforesaid Silica Dispersion 2 was successively mixed with the following additives.

| | |
|---|---|
| 5 percent aqueous polyvinyl alcohol (PVA235, | 180 ml |
| manufactured by Kuraray Industry Co., | |
| Ltd.) solution | |
| 5 percent aqueous polyvinyl alcohol (PVA245, | 80 ml |
| manufactured by Kuraray Industry Co., | |
| Ltd.) solution | |

The total volume was brought to 1,000 ml by the of pure water.

(Preparation of Fourth Layer Liquid Coating Composition)

While stirring at 40° C., 650 ml of aforesaid Silica Dispersion 2 was successively mixed with the following additives.

| | |
|---|---|
| 5 percent aqueous polyvinyl alcohol (PVA235, | 180 ml |
| manufactured by Kuraray Industry Co., | |
| Ltd.) solution | |
| 5 percent aqueous polyvinyl alcohol (PVA245, | 80 ml |
| manufactured by Kuraray Industry Co., | |
| Ltd.) solution | |
| Silicone dispersion (BY-22-839, manufactured | 3.5 ml |
| by Toray-Dow Corning Silicone Co., Ltd.) | |
| 50 percent aqueous saponin solution | 4 ml |
| 5 percent aqueous Surface Active Agent 1 | 6 ml |
| solution | |

The total volume was brought to 1,000 ml by the addition of pure water.

Surface Active Agent 1

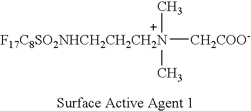

Each of the liquid coating compositions, prepared as above, was subjected to two-stage filtration employing Filter TCP10, manufactured by Toyo Filter Co., Ltd.

All filtrates prepared as above exhibited a viscosity characteristic of 30-80 Pa.s at 40° C., and 30,000-100,000 Pa.s at 15° C.

(Preparation of Recording Sheets 1-5)

Each of the liquid coating compositions prepared as above, was simultaneously applied onto the front side of the aforesaid support coated with polyolefins on both sides in the order of the first layer (35 μm), the second layer (45 μm), the third layer (45 μm), and the fourth layer (40 μm) Each figure in parenthesis is the wet layer thickness.

Each of the liquid coating compositions was subjected to simultaneous multilayer coating at 40° C., employing a four-layer type curtain coater. Immediately after coating, the resulting coating was cooled in an 8° C. cooling zone for 20 seconds. Thereafter, the cooled coating was dried by blowing dried air for 40 seconds under the conditions of 20-30° C. and at most 20 percent relative humidity, for 120 seconds under the conditions of 55° C. and at most 20 percent relative humidity, and for 60 seconds under the conditions of 55° C. and at most relative humidity 30 percent. During such drying, the layer temperature in the constant-rate drying zone was 8-30° C. After gradually increasing the layer temperature in the falling-rate drying zone, the resulting coating was subjected to moisture content control at a relative humidity of 40-60 percent at 23° C. and wound into a roll, whereby Recording Sheets 1-5 were prepared. Each of the resulting recording sheets was then stored at 40° C. for 5 days.

<<Evaluation of Recording Sheets>>

Recording Sheets 1-5, prepared as above, were evaluated for numerical curl value, edge wave resistance, and banding resistance based on the methods below.

(Determination of Numerical Curl Value)

Each A4 size sample was placed on a horizontal plane for 24 hours at each of the ambiences of relative humidity of 20 percent, 55 percent, and 80 percent at 23° C., and the average value of rising heights (in mm) at the four corners was calculated. At that time, the sample was placed so that four corners rise upward from the horizontal plane. The numerical curl value was designated as (+) curl when the ink absorptive layer side was placed upward, while it was designated as (−) curl when the same was placed downward.

(Evaluation of Edge Wave Resistance)

Each sample was allowed to stand for one day at an ambience of 23° C. and relative humidity 20 percent, and subsequently allowed to stand for one day at an ambience of 23° C. and 80 percent relative humidity. Thereafter, the edge wave was visually observed and evaluated based on the criteria below.

A: no waves were noticed at the edges of the sample

B: slight waves were noticed at the edges of the sample but it was within a commercially viable range

C: marked waves were noticed at the edges of the sample and resulted in problems for commercial viability

(Evaluation of Banding Resistance)

Under an ambience of 23° C. and 55 percent relative humidity, the entire surface of A4 sheets which had been evaluated for the aforesaid edge wave resistance was printed employing an ink-jet printer PM920, manufactured by Seiko Epson Corp. Subsequently, formation of streaked unevenness (banding) was visually observed and banding resistance was evaluated based on the criteria below.

A: streaked unevenness was barely noted

B: slight streaked unevenness was noted but was within a commercially viable range

C: marked unevenness was formed on the entire surface and resulted in problems for commercial viability

Table 1 shows the results.

TABLE 1

| Re- | Degree | Numerical | | | | | |
|---|---|---|---|---|---|---|---|
| cord- | of Cobb | Curl Value | | | | | |
| ing | Sizing/ | (mm) | | | Edge | | |
| Sheet | Basis | 20% | 55% | 80% | Wave | Banding | Re- |
| No. | Weight | RH | RH | RH | Resistance | Resistance | marks |
| 1 | 0.08 | +4 | −2 | −5 | A | A | Inv. |
| 2 | 0.16 | +5 | −2 | −6 | A | A | Inv. |
| 3 | 0.25 | +7 | −3 | −7 | B | A | Inv. |
| 4 | 0.36 | +9 | −5 | −9 | B | B | Inv. |
| 5-b | 0.47 | +10 | −6 | −9 | C | C | Comp. |
| 5 | 0.62 | +12 | −6 | −10 | C | C | Comp. |

Inv.; Present Invention
Comp.; Comparative Example

As can clearly be seen from Table 1, comparative Recording Sheets 5-b and 5 at a ratio of the degree of Cobb sizing/basis weight of exceeding 0.4 resulted in a large curl variation under varying ambient humidity, giving a large amount of waving at the edge part of the recording sheet and also in unacceptable levels of banding. Contrary to this, Recording Sheets 1-4 of the present invention at a ratio of the degree of Cobb sizing/basis weight of less than 0.4 resulted in a minimal curl variation under varying relative humidity, minimal numerical curl values and a decrease in edge wave. Specifically, at less than 0.3, neither edge wave nor banding was noted.

### Example 2

Five types of Base Paper 11-15 at a degree of Cobb sizing/basis weight described in Table 2 were prepared in the same manner as the base paper employed to prepare Recording Sheets 1-5 prepared in Example 1, except that the basis weight was changed from 170 g/m² to 120 g/m² and along with this, the amount of polyethylene in the surface containing titanium oxide was varied to result in 22 μm. Subsequently, Recording Sheets 11-15 were prepared in the same manner as Example 1.

Resulting Recording Sheets 11-15 were determined for numerical curl values and evaluated for edge wave resistance as well as banding resistance, employing the methods described in Example 1. Table 2 shows the results.

TABLE 2

| Re- | Degree | Numerical | | | | | |
|---|---|---|---|---|---|---|---|
| cord- | of Cobb | Curl Value | | | | | |
| ing | Sizing/ | (mm) | | | Edge | | |
| Sheet | Basis | 20% | 55% | 80% | Wave | Banding | Re- |
| No. | Weight | RH | RH | RH | Resistance | Resistance | mark |
| 11 | 0.10 | +6 | +3 | −1 | A | A | Inv. |
| 12 | 0.18 | +8 | +3 | −2 | B | A | Inv. |
| 13 | 0.27 | +9 | +4 | −2 | B | A | Inv. |
| 14 | 0.39 | +11 | +6 | −4 | B | B | Inv. |
| 15-b | 0.50 | +13 | +7 | −6 | C | C | Comp. |
| 15 | 0.73 | +16 | +9 | −8 | C | C | Comp. |

Inv.; Present Invention
Comp.; Comparative Example

As can clearly be seen from Table 2, even in the case in which curl control was carried out by changing the basis weight from 170 g/m² to 120 g/m², it was confirmed that the recording sheets of the present invention having the ratio of a degree of Cobb sizing/basis weight, specified in the present invention, exhibited excellent results for curl characteristics, edge wave resistance and banding resistance, which were the same as results for Example 1.

### Example 3

Recording Sheets 21-24 were prepared in the same manner as Example 1, except that in Recording Sheet 2 (at a ratio of the degree of Cobb sizing/basis weight of 0.16) prepared in Example 1, the moisture content was varied as described in Table 3 and each was subjected to evaluation in the same manner as Example 1. Table 3 show the results.

TABLE 3

| | | Numerical | | | | | |
|---|---|---|---|---|---|---|---|
| Re- | Moisture | Curl Value | | | Edge | | |
| cording | Content of | (mm) | | | Wave | Banding | |
| Sheet | Base Paper | 20% | 55% | 80% | Re- | Re- | Re- |
| No. | (weight %) | RH | RH | RH | sistance | sistance | marks |
| 21 | 4.5 | +2 | −1 | −3 | B | A | Inv. |
| 22 | 5.9 | +3 | +1 | −4 | A | A | Inv. |
| 23 | 6.4 | +4 | +2 | −5 | A | A | Inv. |
| 24 | 8.8 | +10 | +2 | −7 | A | B | Inv. |

Inv.; Present Invention

As can clearly be seen from Table 3, each of the recording sheets in which the moisture content was varied from 4.5 to 8.8 percent by weight exhibited almost the desired edge wave resistance as well as banding resistance. Of these, Recording sheet 24 in which the moisture content of the base paper exceeded 8 percent by weight resulted in an increase in curl, and recording sheet 21 in which the moisture content of the base paper was at most 5 percent by weight tended to slightly increase edge wave under an ambience of high humidity.

Based on the present invention, it is possible to provide an ink-jet recording sheet which minimizes curling under varying ambient humidity as well as edge wave and also minimizes image problems and rubbing by heads during ink-jet printing.

What is claimed is:

1. An ink-jet recording sheet comprising a paper support coated with a polyolefin resin on both sides of the paper support, the polyolefin resin-coated paper support having thereon a porous ink receptive layer containing a hydrophilic polymer, wherein the paper support has a ratio of a cobb value to a basis weight of not more than 0.05:1 to 0.4:1.

2. The ink-jet recording sheet of claim 1, wherein the paper support contains water in an amount of 5 to 8 weight % based on the total weight of the paper support.

3. The ink-jet recording support of claim 1, wherein the paper support has a basis weight of not less than 100 g/m².
